(19) United States
(12) Patent Application Publication
(10) Pub. No.: US 2008/0298400 A1
(43) Pub. Date: Dec. 4, 2008

(54) METHOD AND SYSTEM TO DECOMMUTE A VARIABLE SYNCHRONIZATION PATTERN USING A FIXED DECOMMUTATOR

(75) Inventor: Gerhard J. Feichtinger, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/757,567

(22) Filed: Jun. 4, 2007

(51) Int. Cl. H04J 3/06

(52) U.S. Cl. 370/509; 370/503

(57) ABSTRACT

A method for decommutating a variable-synchronization pattern uses a fixed-synchronization decommutator. The method comprises generating N copies of the data stream, receiving one of the N copies of the data stream at a respective one of N fixed decommutator subsystems, receiving synchronized segments of the data stream from each of the N fixed decommutator subsystems at a logical multiplexer, and periodically outputting from the logical multiplexer at least (1/N)^{th} of the synchronized segments of the data stream received from each of the N fixed decommutator subsystems. Each of the N fixed decommutator subsystems is synchronized to a respective synchronization pattern. At least (1/N)^{th} synchronized segments that are sent from each fixed decommutator system are synchronized to the respective synchronization pattern. During each period, the N multiplexed synchronized segments output from the logical multiplexer form a variable synchronized frame of the data stream.

### BACKGROUND

Variable decommutators generate an alternating frame synchronization pattern for use in telemetry applications. Currently available commercial decommutators cannot handle the specific multiple frame synchronization patterns. In order to use the decommutators with alternating frame synchronization pattern, telemetry engineers must truncate the synchronization pattern. When the synchronization pattern is truncated the likelihood of erroneously detecting a synchronization pattern within the decommutated data (referred to as data lock) increases.

### SUMMARY

In a first aspect, a method for decommutating a variable-synchronization pattern using a fixed-synchronization decommutator is provided. The method includes generating N copies of the data stream, receiving one of the N copies of the data stream at a respective one of N fixed decommutator subsystems, receiving synchronized segments of the data stream from each of the N fixed decommutator subsystems at a logical multiplexer, and periodically outputting from the logical multiplexer at least (1/N)^{th} of the synchronized segments of the data stream received from each of the N fixed decommutator subsystems. Each of the N fixed decommutator subsystems is synchronized to a respective synchronization pattern. At least (1/N)^{th} of the synchronized segments that are sent from each fixed decommutator system are synchronized to the respective synchronization pattern. During each period, the N multiplexed synchronized segments output from the logical multiplexer form a variable synchronized frame of the data stream.

### DRAWINGS

FIG. 1 is a block diagram of one embodiment of a decommutator system in accordance with the present invention.

FIG. 2 is a block diagram of one embodiment of a decommutator system in accordance with the present invention.

FIG. 3 is a sketch of one embodiment of an input data stream accordance with the present invention.

FIG. 4A is a sketch of one embodiment of an output data stream in accordance with the present invention.

FIG. 4B is a sketch of one embodiment of an output data stream in accordance with the present invention.

FIG. 5 is a flow diagram of one embodiment of a method for decommutating a variable-synchronization pattern using a fixed-synchronization decommutator in accordance with the present invention.

FIGS. 6 and 7 are a flow diagram of one embodiment of a method for decommutating a variable-synchronization pattern using a fixed-synchronization decommutator in accordance with the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

The decommutator systems described herein include at least two fixed decommutators that each receive copies of a data stream and that each output a data stream that is synchronized to a different synchronization pattern. The output of the at least two fixed decommutators is sent to a logical multiplexer which multiplexes portions of the output received from each of the fixed decommutators. Since the at least two decommutators are synchronized to different synchronization patterns, the output from the logical multiplexer is data stream that has variable synchronized frames.

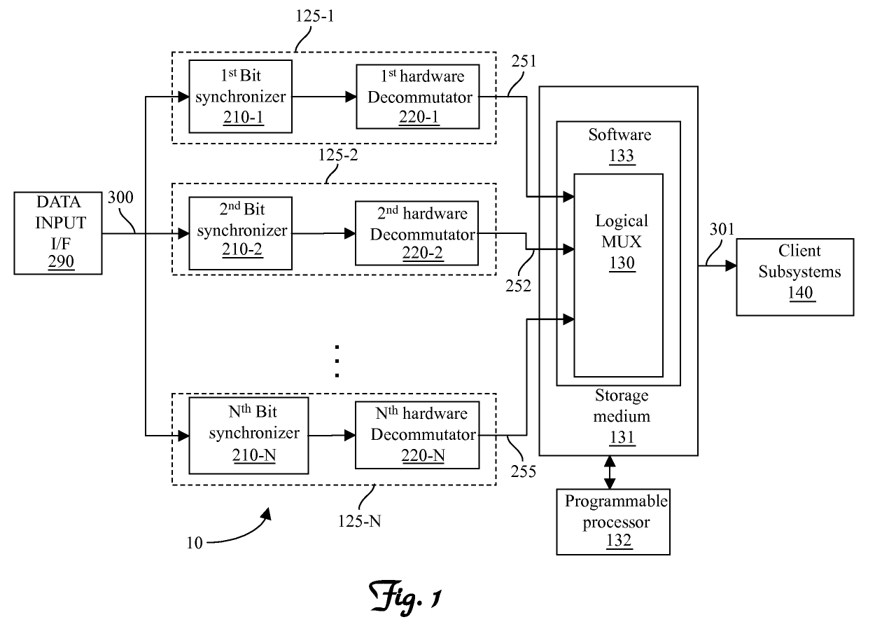

FIG. 1 is a block diagram of one embodiment of a decommutator system 10 in accordance with the present invention. The decommutator system 10 decommutates a variable-synchronization pattern using a plurality of fixed decommutator subsystems 125 (1-N). The fixed decommutator subsystems 125 (1-N) each include a respective bit synchronizer 210 (1-N) and a respective hardware decommutator 220 (1-N). Each of the least two fixed decommutator subsystems 125 (1-N) receives identical data streams from a data input interface 290 via a link 300. The link 300 communicatively couples the data input interface 290 to each of the fixed decommutator subsystems 125 (1-N). The link 300 can be a wireless communication link (for example, a radio-frequency (RF) communication link) and/or a wired communication link (for example, an optical fiber or copper wire communication link).

In one implementation of this embodiment, each fixed decommutator subsystem 125 (1-N) segments the data stream, synchronizes each segment to a synchronization pattern of the respective fixed decommutator subsystem (125 (1-N) and outputs the synchronized segments to the logical multiplexer 130. In another implementation of this embodiment, each fixed decommutator subsystem 125 (1-N) segments the data stream, attaches every Nth segment to a synchronization pattern of the respective fixed decommutator subsystem (125 (1-N) and outputs only the synchronized segments to the logical multiplexer 130. In yet another implementation of this embodiment, each fixed decommutator subsystem 125 (1-N) segments the data stream, attaches every Nth segment to a synchronization pattern of the respective fixed decommutator subsystem 125 (1-N) and outputs the synchronized segments and the un-synchronized segments to the logical multiplexer 130.

In an exemplary embodiment, the bit synchronizers 210 (1-N) periodically insert a synchronization pattern, such as a hexadecimal bit pattern 1A05, 1A1A, or 1A15, after a selected number of sequentially received bits in the data stream so that all the bits in the data stream are synchronized. The hardware decommutators 220 (1-N) output the synchronized bits to the logical multiplexer 130.

The first bit synchronizer 210-1 outputs the synchronized bits to the first hardware decommutator 220-1. The second bit synchronizer 210-2 outputs the synchronized bits to the second hardware decommutator 220-2. The N^{th} bit synchronizer 210-3 outputs the synchronized bits to the N^{th} hardware decommutator 220-3.

The logical multiplexer 130 receives the synchronized segments of the data stream output from all of the fixed decommutator subsystems 125 (1-N). The first fixed decommutator subsystem 125-1 is communicatively coupled to the logical multiplexer 130 via link 251. The second fixed decommutator subsystem 125-2 is communicatively coupled to the logical multiplexer 130 via line 252. The N^{th} fixed decommutator subsystem 125-N is communicatively coupled to the logical multiplexer 130 via link 255. Other fixed decommutator subsystems 125 are communicatively coupled to the logical multiplexer 130 via other links (not shown). The links 251, 252, 255 can be a wireless communication link (for example, a radio-frequency (RF) communication link) and/or a wired communication link (for example, an optical fiber or copper wire communication link) to transmit bits of a serial data stream.

The logical multiplexer 130 periodically outputs, in an interleaved manner, at least a portion of the synchronized segments received from each fixed decommutator to a user. The output from the logical multiplexer 130 during one period is a variable synchronized frame of the data stream. In the embodiment in which all the segments output by the fixed decommutator subsystems 125 (1-N) are synchronized to the synchronization pattern, the logical multiplexer 130 periodically outputs a (1/N)^{th} of the synchronized segments received from each fixed decommutator to a client subsystem 140 via link 301. The link 301 can be a wireless communication link (for example, a radio-frequency (RF) communication link) and/or a wired communication link (for example, an optical fiber or copper wire communication link) to transmit bits of a serial data stream. In the embodiment in which the fixed decommutator subsystems 125 (1-N) output only one synchronized segment per period, the logical multiplexer 130 periodically outputs all the synchronized segments received from each fixed decommutator to a client subsystem 140 via link 301.

The operation instructions of the logical multiplexer 130, which comprises a portion of the software 133, are processed by a programmable processor 132. The programmable processor 132 executes software 133 and/or firmware that causes the programmable processor 132 to perform at least some of the processing described here as being performed by the logical multiplexer 130. At least a portion of such software 133 and/or firmware executed by the programmable processor 132 and any related data structures are stored in storage medium 131 during execution. In one implementation, the programmable processor 132 comprises a microprocessor or microcontroller. In one implementation, the programmable processor 132 comprises processor support chips and/or system support chips such as ASICs.

Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).”

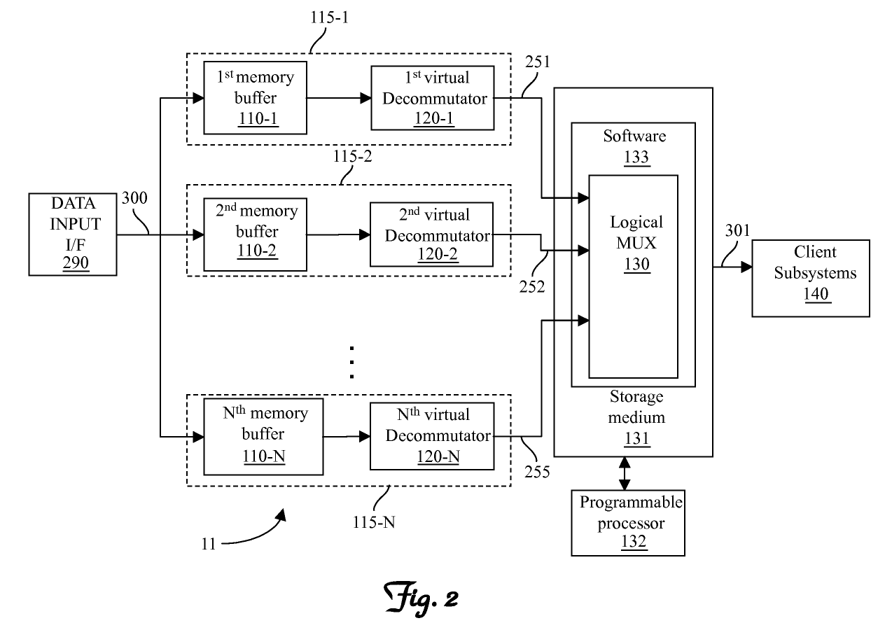

FIG. 2 is a block diagram of one embodiment of a decommutator system 11 in accordance with the present invention. The decommutator system 11 decommutates a variable-synchronization pattern using a plurality of fixed decommutator subsystems 115 (1-N). The fixed decommutator subsystems 115 (1-N) each include a respective memory buffer 110 (1-N) and a respective virtual decommutator 120 (1-N). Each of the least two fixed decommutator subsystems 115 (1-N) receives identical data streams from a data input interface 290 via a link 300. The link 300 communicatively couples the data input interface 290 to each of the fixed decommutator subsystems 115 (1-N).

In one implementation of this embodiment, each fixed decommutator subsystem 115 (1-N) segments the data stream, attaches each segment to a synchronization pattern of the respective fixed decommutator subsystem (115 (1-N) and outputs the synchronized segments to the logical multiplexer 130. The memory buffers 110 (1-N) buffer the received serial data stream and the virtual decommutators 120 (1-N) serialize the data stream by periodically inserting a synchronization pattern, such as a hexadecimal bit pattern 1A05,1A1A, or 1A15 after a selected number of sequentially buffered bits. Each of the virtual decommutators 120 (1-N) outputs the synchronized bits to the logical multiplexer 130.

In another implementation of this embodiment, each fixed decommutator subsystem 115 (1-N) segments the data stream, attaches every N^{th} segment to a synchronization pattern of the respective fixed decommutator subsystem (115 (1-N) and outputs only the synchronized segments to the logical multiplexer 130. In yet another implementation of this embodiment, each fixed decommutator subsystem 115 (1-N) segments the data stream, attaches every N^{th} segment to a synchronization pattern of the respective fixed decommutator subsystem 115 (1-N) and outputs the synchronized segments and the un-synchronized segments to the logical multiplexer 130.

The first memory buffer 110-1 buffers bits for the first virtual decommutator 120-1. The second memory buffer 110-2 buffers bits for the second virtual decommutator 120-2. The third memory buffer 110-3 buffers bits for the third virtual decommutator 120-3.

The logical multiplexer 130 receives the synchronized segments of the data stream output from all of the fixed decommutator subsystems 115 (1-N). The first fixed decommutator subsystem 115-1 is communicatively coupled to the logical multiplexer 130 via link 251. The second fixed decommutator subsystem 115-2 is communicatively coupled to the logical multiplexer 130 via line 252. The N^{th} fixed decommutator subsystem 115-N is communicatively coupled to the logical multiplexer 130 via link 255. Other fixed decommutator subsystems 115 are communicatively coupled to the logical multiplexer 130 via other links (not shown).

The logical multiplexer 130 periodically outputs, in an interleaved manner, at least a portion of the synchronized segments received from each fixed decommutator subsystem 115 (1-N) to a user, such as the client subsystems 140. The logical multiplexer 130, the software 133, the storage medium 131 and the programmable processor 132 are structured to function in the manner described above with reference to FIG. 1.

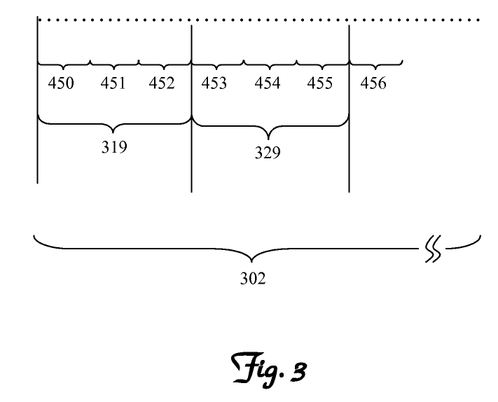

FIG. 3 is a sketch of one embodiment of an input data stream represented generally by the numeral 302 accordance with the present invention. The bits in the serial input data stream 302 that are input via communication link 300 to the fixed decommutator subsystems 125 (1-N) or 115 (1-N) of FIG. 1 or FIG. 2, respectively, are represented as dots in FIG. 3. The bits in the serial data stream 302 are segmented into equal size segments represented generally by the numerals 450-456. The segments 450-456 are representative of all the segments in the complete data stream and are not meant to limit the number of segments in the data stream to seven segments. As shown in FIG. 3, the first three sequential segments of the data stream 302 form a first bit frame 319 and the second three sequential segments of the data stream 302 form a second bit frame 329.

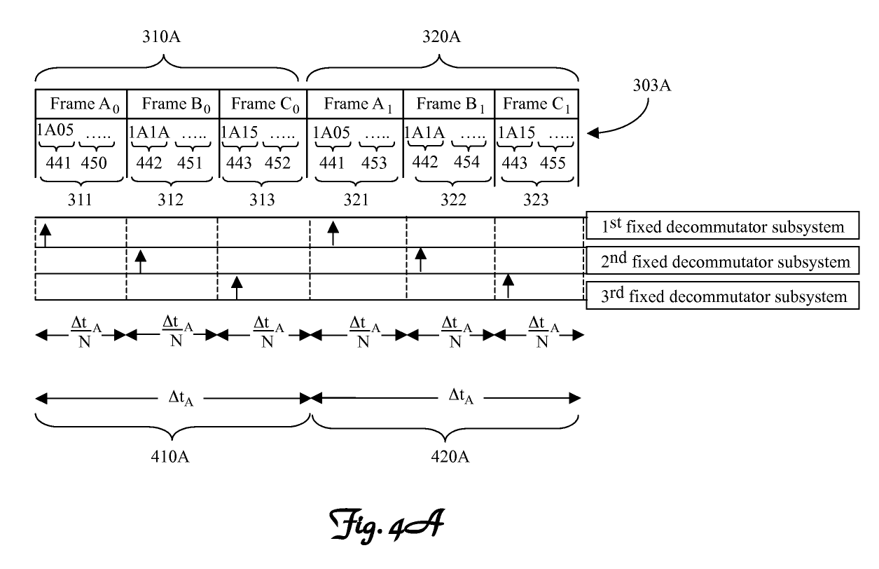

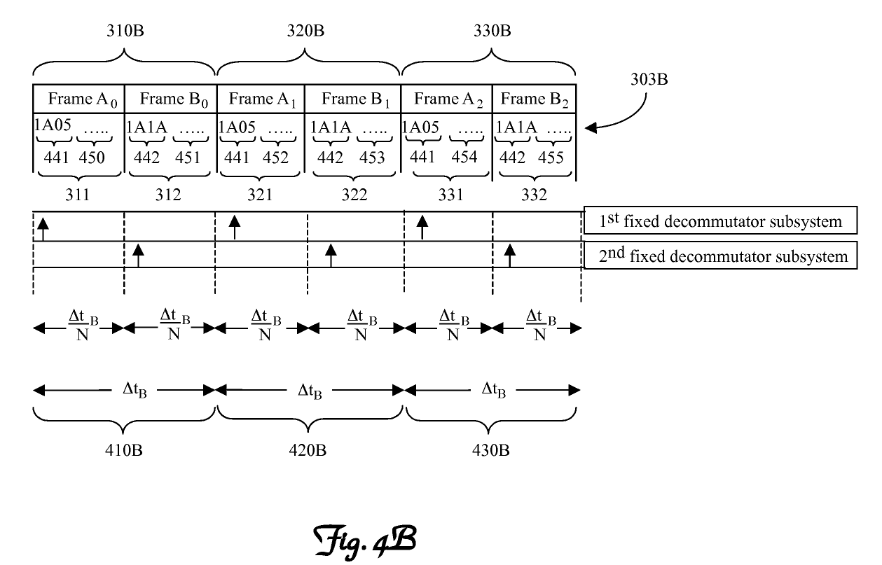

FIG. 4A is a sketch of one embodiment of an output data stream represented generally by the numeral 303A in accordance with the present invention. As shown in FIG. 4A, the bits in the serial output data stream 303A that are output via link 301 from the decommutator system 10 or decommutator system 11 of FIG. 1 or FIG. 2, respectively, are represented as interleaved hexadecimal codes 441-443 and segments 450-455. The hexadecimal codes are the synchronization patterns. As shown in FIG. 4A, the hexadecimal code 441 is the string of bits 1A05, the hexadecimal code 442 is the string of bits 1A1A, and the hexadecimal code 443 is the string of bits 1A15. These exemplary synchronization patterns are shown in Table 1 below. The three synchronized segments 311, 312 and 313 are concatenated to form a variable synchronization frame 310A of the data stream 302 (FIG. 3) during a first period 410A having a duration of Δt_{A}. Likewise, the three synchronized segments 321, 322, and 323 are concatenated to form a variable synchronization frame 320A of the data stream 302 (FIG. 3) during a second period 420A having a duration of Δt_{A}.

TABLE 1
Synchronization patterns

| SYNC | 0 | | | | | | | | | | | | | | | 15 |
|---|---|---|---|---|---|---|---|---|---|---|---|---|---|---|---|---|
| (HEX) | (MSB) | 1 | 2 | 3 | 4 | 5 | 6 | 7 | 8 | 9 | 10 | 11 | 12 | 13 | 14 | (LSB) |
| 1A05 | 0 | 0 | 0 | 1 | 1 | 0 | 1 | 0 | 0 | 0 | 0 | 0 | 0 | 1 | 0 | 1 |
| 1A1A | 0 | 0 | 0 | 1 | 1 | 0 | 1 | 0 | 0 | 0 | 0 | 1 | 1 | 0 | 1 | 0 |
| 1A15 | 0 | 0 | 0 | 1 | 1 | 0 | 1 | 0 | 0 | 0 | 0 | 1 | 0 | 1 | 0 | 1 |

The arrows under synchronized segments 311 and 321 indicate the times at which the logical multiplexer 130 outputs the synchronized segments 311 and 321 received from the first decommutator subsystem, such as fixed decommutator subsystem 115-1 or 125-1. The arrows under synchronized segments 312 and 322 indicate the times at which the logical multiplexer 130 outputs the synchronized segments 312 and 322 received from the second decommutator subsystem, such as fixed decommutator subsystem 115-2 or 125-2. The arrows under synchronized segments 313 and 323 indicate the times at which the logical multiplexer 130 outputs the synchronized segments 313 and 323 received from the third decommutator subsystem, such as fixed decommutator subsystem 115-3 or 125-3.

FIG. 4B is a sketch of one embodiment of an output data stream represented generally by the numeral 303B in accordance with the present invention. As shown in FIG. 4B, the bits in the serial output data stream 303B that are output via link 301 from the decommutator system 10 or decommutator system 11 of FIG. 1 or FIG. 2, respectively, are represented as interleaved hexadecimal codes 441-442 and segments 450-455. The two synchronized segments 311 and 312 are concatenated to form a variable synchronization frame 310B of the data stream 302 (FIG. 3) during a first period 410B having a duration of Δt_{B}. Likewise, the two synchronized segments 321 and 322 are concatenated to form a variable synchronization frame 320B of the data stream 302 (FIG. 3) during a second period 420B having a duration of Δt_{B}. Additionally, the two synchronized segments 331 and 332 are concatenated to form a variable synchronization frame 330B of the data stream 302 (FIG. 3) during a third period 430B having a duration of Δt_{B}.

The arrows under synchronized segments 311, 321 and 331 indicate the times at which the logical multiplexer 130 outputs the synchronized segments 311, 321 and 331 received from the first decommutator subsystem, such as fixed decommutator subsystem 115-1 or 125-1. The arrows under synchronized segments 312, 322 and 332 indicate the times at which the logical multiplexer 130 outputs the synchronized segments 312, 322 and 332 received from the second decommutator subsystem, such as fixed decommutator subsystem 115-2 or 125-2.

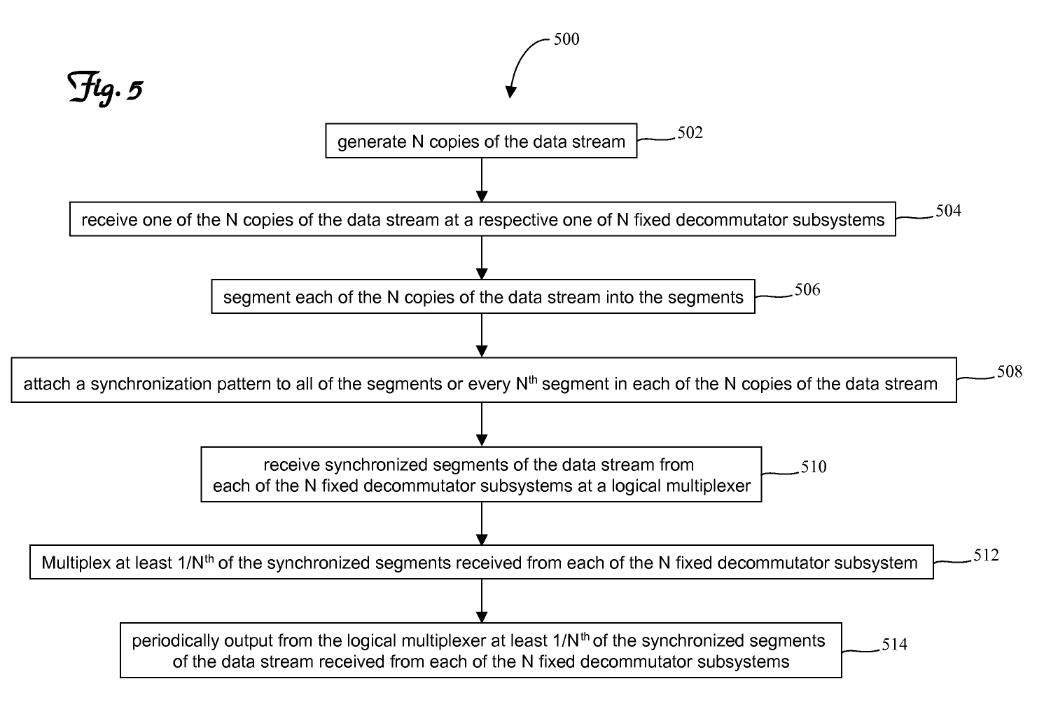

FIG. 5 is a flow diagram of one embodiment of a method 500 for decommutating a variable-synchronization pattern using a fixed-synchronization decommutator in accordance with the present invention. The method 500 is described with reference to the input data stream 302 of FIG. 3 being input to the fixed decommutator subsystems 125 (1-N) of FIG. 1 and with reference to the output data stream 303A of FIG. 4A being output from the fixed decommutator subsystems 125 (1-N). In another implementation of this embodiment, method 500 is implemented by the fixed decommutator subsystems 115 (1-N) of FIG. 2. The term “fixed-synchronization decommutator” is referred to herein as “fixed decommutator subsystems 125 (1-N)” and/or “fixed decommutator subsystems 115 (1-N).”

At block 502, N copies of the data stream 302 are generated. The data input interface 290 outputs the data steam 302 via link 300. In one implementation of this embodiment, generating N copies of the data stream comprises generating N copies of a data stream having a fixed data rate. In another implementation of this embodiment, the fixed data rate is 1/Δt_{A}. In yet another implementation of this embodiment, the fixed data rate is 1/Δt_{B}. In yet another implementation of this embodiment, generating N copies of the data stream 302 comprises storing the data stream in N memory buffers 110 (1-N) of N respective virtual decommutators 115 (1-N). In yet another implementation of this embodiment, generating N copies of the data stream comprises physically replicating N copies of the data stream 320 in bit synchronizers (210 (1-N) of N respective hardware decommutators 220 (1-N).

At block 504, one of the N copies of the data stream is received at a respective one of the N fixed decommutator subsystems. In one implementation of this embodiment, a first copy of the data stream 302 is received at a first fixed decommutator subsystem 125-1 synchronized to a first synchronization pattern 441. In another implementation of this embodiment, the synchronization pattern 441 is the hexadecimal bit pattern 1A1A. In yet another implementation of this embodiment, one of the N copies of the data stream 302 is received at a respective one of the N fixed decommutator subsystems 125-i. In this manner, the first bit synchronizer 210-1, the second bit synchronizer 210-2 and the N^{th} bit synchronizer 210-N each receive a copy of the data stream 302. In yet another implementation of this embodiment, one of the N copies of the data stream 302 is received at a respective one of the N fixed decommutator subsystems 115-i (FIG. 2).

At block 506, the N copies of the data stream are segmented into segments. In one implementation of this embodiment, the first bit synchronizer 210-1, the second bit synchronizer 210-2 and the N^{th} bit synchronizer 210-N each segment the data stream 302 into segments 450-456 (FIG. 3).

At block 508, the fixed decommutator subsystems each attach as synchronization pattern to all of the segments or every Nth of the segments in each of the N copies of the data stream. In one implementation of this embodiment, the fixed decommutator subsystems 125 (1-N) each attach a synchronization pattern to all of the segments 450-456. For example, the first synchronization pattern 441, which includes the hexadecimal bit pattern 1A05, is attached to the segments 450-456 by the first fixed decommutator subsystem 125-1. At the same time, a second synchronization pattern 442, which includes the hexadecimal bit pattern 1A1A, is attached to the segments 450-456 by the second fixed decommutator subsystem 125-2 while the third synchronization pattern 443, which includes the hexadecimal bit pattern 1A15, is attached to the segments 450-456 by the third fixed decommutator subsystem 125-3. In like manner, all of the other fixed decommutator subsystems 125 (4-N) in the decommutator system 10 attach other hexadecimal bit patterns to the segments 450-456. In one implementation of this embodiment, at least two fixed decommutator subsystems have the same synchronization pattern.

In another implementation of this embodiment, the fixed decommutator subsystems 125 (1-N) each attach a synchronization pattern to every Nth of the segments 450-456. For example, the first synchronization pattern is attached to every third segment, that is segments 450 and 453 (FIG. 3) by the first fixed decommutator subsystem 125-1. At the same time, a second synchronization pattern 442 is attached to every third segment, that is segments 451 and 454 (FIG. 3), by the second fixed decommutator subsystem 125-2 while the third synchronization pattern 443 is attached to every third segment, that is segments 452 and 455 (FIG. 3), by the third fixed decommutator subsystem 125-3. In this exemplary case, there are three decommutators.

At block 510, the logical multiplexer receives synchronized segments of the data stream from each of the N fixed decommutator subsystems. The synchronized segment sent from each fixed decommutator is synchronized to the respective synchronization pattern. In one implementation of this embodiment, the logical multiplexer 130 receives all the synchronized segments of the data stream 302 from each of the N fixed decommutator subsystems 125 (1-N) (FIG. 1). In one implementation of the case in which the decommutator only attaches the synchronization pattern to every Nth segment, the logical multiplexer 130 only receives the segment to which the synchronization pattern has been added from each of the fixed decommutator subsystems 125 (1-N). In another implementation of the case in which the decommutator only attaches the synchronization pattern to every Nth segment, the logical multiplexer 130 receives all the segments from each of the fixed decommutator subsystems 125 (1-N).

In an exemplary case, the logical multiplexer 130 receives the hexadecimal bit pattern 1A05 attached to the segments 450-456 from the first fixed decommutator subsystem 125-1 as at least synchronized segment 311 and 321. In this exemplary case, the logical multiplexer 130 receives the hexadecimal bit pattern 1A1A attached to the segments 450-456 from the second fixed decommutator subsystem 125-2 as at least synchronized segment 312 and 322. Also, in this exemplary case, the logical multiplexer 130 receives the hexadecimal bit pattern 1A15 attached to the segments 450-456 from the third fixed decommutator subsystem 125-3 as at least synchronized segment 313 and 323.

At block 512, the logical multiplexer multiplexes at least (1/N)^{th} of the synchronized segments received from each of the N fixed decommutators to form the output data stream. During each period, such as Δt_{A}, the N multiplexed synchronized segments output from the logical multiplexer 130 form a variable synchronized frame 310A of the data stream 303A. In one implementation of this embodiment, the logical multiplexer 130 multiplexes (1/N)^{th} of the synchronized segments 450-456 received from each of the N fixed decommutator systems 125 (1-N) (FIG. 1) to form the output data stream 303A. In another implementation of this embodiment, the logical multiplexer 130 multiplexes (1/N)^{th} of the synchronized segments 450-456 received from each of the N fixed decommutator systems 115 (1-N) (FIG. 2) to form the output data stream 303A.

An exemplary implementation of the output data stream 300A is shown in FIG. 4A, in which the logical multiplexer 130 is multiplexing data streams from three fixed decommutator subsystems 125-1, 125-2, and 125-3. In this exemplary case, N equals three (3). As shown in FIG. 4A, the logical multiplexer 130 multiplexes the hexadecimal bit pattern 1A05 attached to the segment 450 (synchronized segment 311) that was received from the first fixed decommutator subsystem 125-1 during the first timeslot starting at time t₀. Also, the logical multiplexer 130 multiplexes the hexadecimal bit pattern 1A05 attached to the segment 453 (synchronized segment 321) from the first fixed decommutator subsystem 125-1 during the fourth time slot (3Δt_{A}+t₀). As long as the data stream is being sent to the logical multiplexer 130, the logical multiplexer 130 continues to multiplex the hexadecimal bit pattern 1A05 attached to one of the segments (synchronized segments) received from the first fixed decommutator subsystem 125-1 during every timeslot starting at time (nΔt_{A}+t₀). The time Δt_{A} is the period of the complete synchronized frame of the data stream 410A and ‘n’ is an integer. Every timeslot has a duration of Δt_{A}/3.

Also, in the exemplary embodiment, the logical multiplexer 130 multiplexes into data stream 303A the hexadecimal bit pattern 1A1A attached to the segment 451 (synchronized segment 312) received from the second fixed decommutator subsystem 125-2 during the second timeslot starting at time (t₀+Δt_{A}/3). Also, the logical multiplexer 130 multiplexes the hexadecimal bit pattern 1A1A attached to the segment 454 (synchronized segment 322) received from the second fixed decommutator subsystem 125-2 during the fifth time slot (3Δt_{A}+t₀). As long as the data stream is being sent to the logical multiplexer 130, the logical multiplexer 130 continues to multiplex the hexadecimal bit pattern 1A1A attached to one of the segments (synchronized segments) received from the second fixed decommutator subsystem 125-2 during every timeslot starting at time (nΔt_{A+}⅓Δt+t₀).

Also, in the exemplary embodiment, the logical multiplexer 130 multiplexes into data stream 303A the hexadecimal bit pattern 1A15 attached to the segments 452 (synchronized segment 313) received from the third fixed decommutator subsystem 125-3 during the third timeslot starting at the time (t₀+2Δt_{A}/3). Also, the logical multiplexer 130 multiplexes the hexadecimal bit pattern 1A15 attached to the segment 455 (synchronized segment 323) during the sixth timeslot (6Δt_{A}+t₀). As long as the data stream is being sent to the logical multiplexer 130, the logical multiplexer 130 continues to multiplex the hexadecimal bit pattern 1A15 attached to one of the segments (synchronized segments) received from the third fixed decommutator subsystem 125-3 during every timeslot starting at time (nΔt_{A}+⅔Δt_{A}+t₀).

Thus during the first period 410A of duration Δt_{A}, the three multiplexed synchronized segments 311-313 are output from the logical multiplexer 130 and form a variable synchronized frame 310A of the data stream 303A.

In another implementation of the case in which the decommutator only attaches the synchronization pattern to every Nth segment, the logical multiplexer 130 only receives the segment to which the synchronization pattern has been added from each of the fixed decommutator subsystems 125 (1-N) and the logical multiplexer 130 multiplexes each of the segments received from each of the fixed decommutator subsystems 125 (1-N).

At block 514, the logical multiplexer 130 periodically outputs at least (1/N)^{th} of the synchronized segments of the data stream received from each of the N fixed decommutator subsystems. During each period, the N multiplexed synchronized segments, such as 311-313, output from the logical multiplexer 130 form a variable synchronized frame, such as 310A, of the data stream 303A. In one implementation of this embodiment, periodically outputting (1/N)^{th} of the synchronized segments of the data stream received from each of the N fixed decommutator subsystems comprises periodically outputting a segment of the data stream received from one of the N fixed decommutator subsystems at a data rate equal to N times the fixed data rate. In another implementation of this embodiment, the N times the fixed data rate is N/Δt_{A}. In yet another implementation of this embodiment, the fixed data rate is N/Δt_{B}.

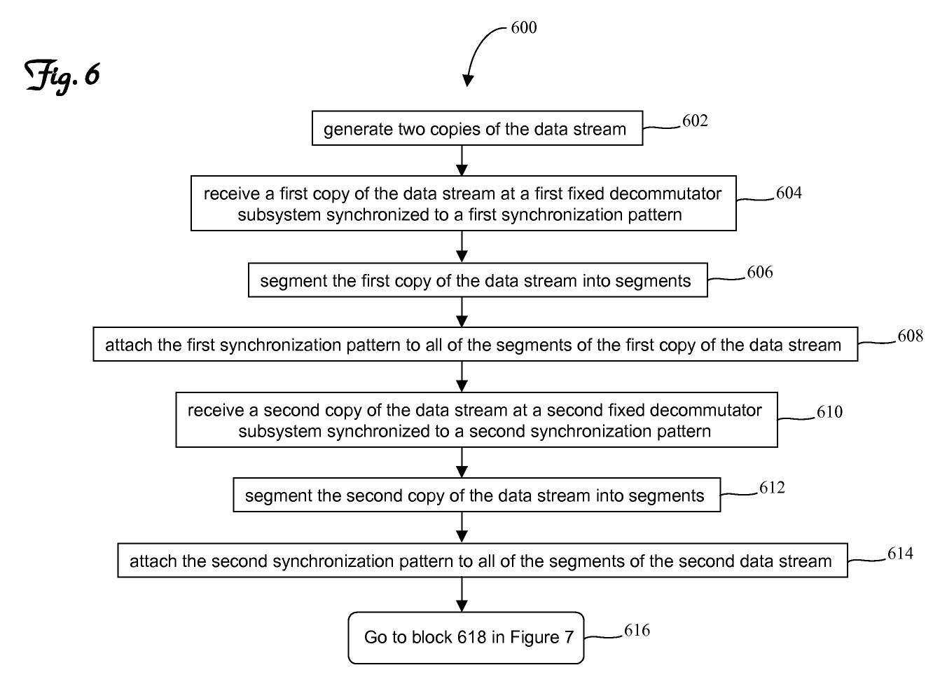

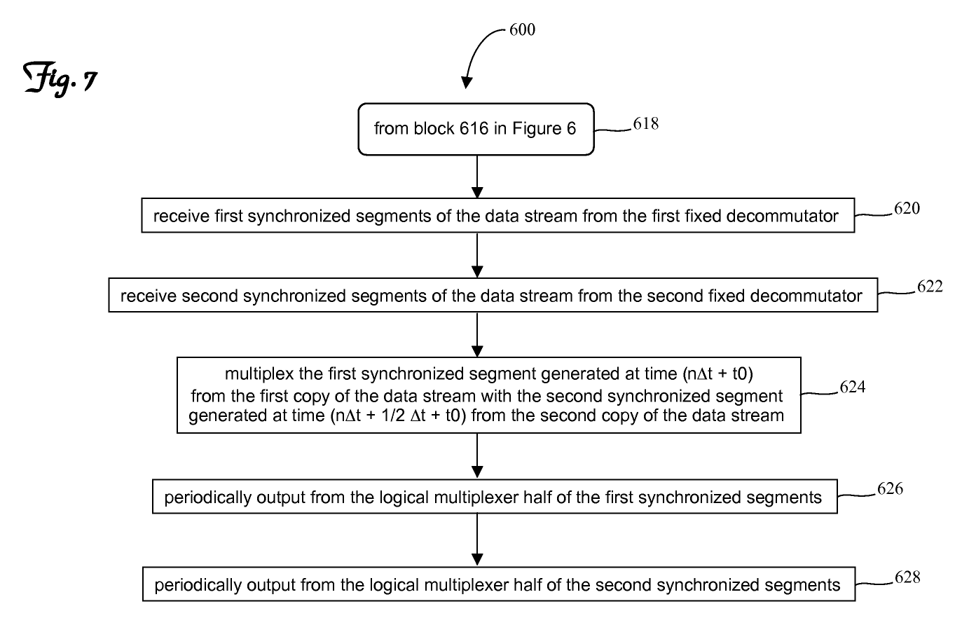

FIGS. 6 and 7 are a flow diagram of one embodiment of a method 600 for decommutating a variable-synchronization pattern using a fixed-synchronization decommutator in accordance with the present invention. The method 600 is described with reference to the input data stream 302 of FIG. 3 being input to the fixed decommutator subsystems 125 (1-N) of FIG. 1 and with reference to the output data stream 303B of FIG. 4B being output from the fixed decommutator subsystems 125 (1-N). In another implementation of this embodiment, method 600 is implemented by the fixed decommutator subsystems 115 (1-N) of FIG. 2.

At block 602, two copies of the data stream are generated. In one implementation of this embodiment, two copies of the data stream 302 are generated and the data input interface 290 outputs the data steam 302 via link 300 as described above with reference to block 502 of method 5 in FIG. 5.

At block 604, a first copy of the data stream is received at a first fixed decommutator subsystem synchronized to a first synchronization pattern. In one implementation of this embodiment, a first copy of the data stream 302 is received at a first fixed decommutator subsystem 125-1 synchronized to a first synchronization pattern 441. In another implementation of this embodiment, the synchronization pattern 441 is the hexadecimal bit pattern 1A1A.

At block 606, the first fixed decommutator subsystem segments the first copy of the data stream into segments. In one implementation of this embodiment, the first fixed decommutator subsystem 125-1 segments the first copy of the data stream 302 into segments, such as segments 450-456.

At block 608, the first fixed decommutator subsystem attaches the first synchronization pattern to all of the segments of the first copy of the data stream to form first synchronized segments. In one implementation of this embodiment, the first fixed decommutator subsystem 125-1 attaches the first synchronization pattern 441 to all of the segments 450-456 of the first copy of the data stream 302 to form first synchronized segments that include at least 311, 321, and 331.

At block 610, a second copy of the data stream is received at a second fixed decommutator subsystem synchronized to a second synchronization pattern. In one implementation of this embodiment, a second copy of the data stream 302 is received at a second fixed decommutator subsystem 125-2 synchronized to a second synchronization pattern 442. In another implementation of this embodiment, the synchronization pattern 442 is the hexadecimal bit pattern 1A05.

At block 612, the second fixed decommutator subsystem segments the second copy of the data stream into segments. In one implementation of this embodiment, the second fixed decommutator subsystem 125-2 segments the second copy of the data stream 302 into segments, such as segments 450-456.

At block 614, the second fixed decommutator subsystem attaches the second synchronization pattern to all of the segments of the second copy of the data stream to form second synchronized segments. In one implementation of this embodiment, the second fixed decommutator subsystem 125-2 attaches the second synchronization pattern 442 to all of the segments 450-456 of the second copy of the data stream 302 to form second synchronized segments that include at least 312, 322, and 332.

At block 616, the flow is directed to block 618 in FIG. 7. At block 618 in FIG. 7, the flow proceeds from block 616. At block 620, the logical multiplexer receives first synchronized segments of the data stream from the first fixed decommutator. In one implementation of this embodiment, the logical multiplexer 130 receives first synchronized segments 311, 321, and 331 of the data stream 302 from the first fixed decommutator 125-1.

At block 622, the logical multiplexer receives second synchronized segments of the data stream from the second fixed decommutator. In one implementation of this embodiment, the logical multiplexer 130 receives second synchronized segments 312, 322, and 332 of the data stream 302 from the second fixed decommutator 125-2.

At block 624, the logical multiplexer 130 multiplexes the first synchronized segments generated at time (nΔt+t₀) from the first copy of the data stream with the second synchronized segment generated at time ((n+½)Δt+t₀) from the second copy of the data stream. For example, the logical multiplexer 130 multiplexes the first synchronized segment 311 generated at t₀ from the first copy of the data stream 320 with the second synchronized segment 312 generated at time (½Δt+t₀). Then the logical multiplexer 130 multiplexes the first synchronized segment 311 generated at (Δt+t₀) from the first copy of the data stream 320 with the second synchronized segment 312 generated at time ( 3/2Δt+t₀).

At block 626, the logical multiplexer periodically outputs half of the first synchronized segments. In one implementation of this embodiment, the logical multiplexer 130 periodically outputs the half of the first synchronized segments that include 311, 321, and 331. In one implementation of this embodiment, the first fixed decommutator subsystem 125-1 only outputs every other one of the segments from the data stream 302 which are formed into the synchronized segments. In that case, the logical multiplexer periodically outputs all of the first synchronized segments received from the first fixed decommutator subsystem 125-1.

At block 628, the logical multiplexer periodically outputs half of the second synchronized segments. In one implementation of this embodiment, the logical multiplexer 130 periodically outputs the half of the second synchronized segments that include 312, 322, and 332. In another implementation of this embodiment, the first fixed decommutator subsystem 125-1 only outputs every other one of the segments from the data stream 302 which are formed into the second synchronized segments. In that case, the logical multiplexer 130 periodically outputs all of the second synchronized segments received from the first fixed decommutator subsystem 125-2.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method for decommutating a variable-synchronization pattern using a fixed-synchronization decommutator, the method comprising:
generating N copies of the data stream;
receiving one of the N copies of the data stream at a respective one of N fixed decommutator subsystems, each of the N fixed decommutator subsystems synchronized to a respective synchronization pattern;
receiving synchronized segments of the data stream from each of the N fixed decommutator subsystems at a logical multiplexer, wherein at least (1/N)^{th} of the synchronized segments sent from each fixed decommutator system are synchronized to the respective synchronization pattern; and
periodically outputting from the logical multiplexer at least (1/N)^{th} of the synchronized segments of the data stream received from each of the N fixed decommutator subsystems, wherein during each period, the N multiplexed synchronized segments output from the logical multiplexer form a variable synchronized frame of the data stream.

2. The method of claim 1, wherein generating N copies of the data stream comprises generating N copies of a data stream having a fixed data rate.

3. The method of claim 2, wherein periodically outputting (1/N)^{th} of the synchronized segments of the data stream received from each of the N fixed decommutator subsystems comprises periodically outputting a segment of the data stream received from one of the N fixed decommutator subsystems at a data rate equal to N times the fixed data rate.

4. The method of claim 1, further comprising:
segmenting each of the N copies of the data stream into the segments; and
attaching a synchronization pattern to all of the segments for each of the N copies of the data stream to form synchronized segments.

5. The method of claim 4, further comprising:
multiplexing at least (1/N)^{th} of the synchronized segments received from each of the N fixed decommutators.

6. The method of claim 1, wherein generating N copies of a data stream comprises
generating two copies of the data stream,
wherein receiving one of the N copies of the data stream at a respective one of N fixed decommutator subsystems includes:
receiving a first copy of the data stream at a first fixed decommutator subsystem synchronized to a first synchronization pattern; and
receiving a second copy of the data stream at a second fixed decommutator subsystem synchronized to a second synchronization pattern,
wherein receiving synchronized segments of the data stream from each of the N fixed decommutator subsystems comprises:
receiving first synchronized segments of the data stream from the first fixed decommutator; and
receiving second synchronized segments of the data stream from the second fixed decommutator, and
wherein periodically outputting from the logical multiplexer (1/N)^{th} of the synchronized segments of the data stream received from each of the N fixed decommutator subsystems comprises:
periodically outputting from the logical multiplexer half of the first synchronized segments; and
periodically outputting from the logical multiplexer half of the second synchronized segments, wherein during each period, one of the first synchronized segments is output from the logical multiplexer before one of the second synchronized segments.

7. The method of claim 6, further comprising:
segmenting the first copy of the data stream into segments;
attaching the first synchronization pattern to all of the segments of the first copy of the data stream to form first synchronized segments;
segmenting the second copy of the data stream into segments; and
attaching the second synchronization pattern to all of the segments of the second data stream to form second synchronized segments.

8. The method of claim 7, further comprising:
multiplexing the first synchronized segment generated at time (nΔt+t₀) from the first copy of the data stream with the second synchronized segment generated at time (nΔt+½Δt+t₀) from the second copy of the data stream.

9. The method of claim 1, wherein generating N copies of the data stream comprises
storing the data stream in N memory buffers of N respective virtual decommutators.

10. The method of claim 1, wherein generating N copies of the data stream comprises
physically replicating N copies of the data stream in bit synchronizers of N respective hardware decommutators.

11. The method of claim 1, further comprising:
segmenting each of the N copies of the data stream into the segments;
attaching a synchronization pattern to every N^{th} segment for each of the N copies of the data stream to form a synchronized segment for every N^{th} segment.

12. The method of claim 11, the method further comprising:
multiplexing the synchronized segments from each of the data streams.
wherein periodically outputting from the logical multiplexer at least (1/N)^{th} of the synchronized segments of the data stream received from each of the N fixed decommutator subsystems comprises periodically outputting from the logical multiplexer all the synchronized segments of the data stream received from each of the N fixed decommutator subsystems.

13. A system to decommutate a variable-synchronization pattern using a fixed-synchronization decommutator, the system comprising:
at least two fixed decommutator subsystems to receive identical data streams, where each fixed decommutator subsystem is operable to segment the data stream, to synchronize each segment to synchronization pattern of the respective fixed decommutator subsystem and to output the synchronized segments;
a logical multiplexer operable to receive the synchronized segments of the data stream output from all of the fixed decommutator subsystems, and to periodically output, in an interleaved manner, a portion of the synchronized segments received from each fixed decommutator, wherein the output from the logical multiplexer during one period is a complete frame of the data stream.

14. The system of claim 13, wherein each fixed decommutator subsystem comprises:
a memory buffer to buffer the data stream; and
a virtual decommutator to serialize the memory buffer, to periodically insert a synchronization pattern to a selected number of sequentially received bits in the data stream, and to output the synchronized bits to the logical multiplexer.

15. The system of claim 13, wherein each fixed decommutator subsystem comprises:
a bit synchronizer to periodically insert a synchronization pattern after a selected number of sequentially received bits in the data stream, wherein all the bits in the data stream are synchronized; and
a hardware decommutator to output the synchronized bits to the logical multiplexer.

16. The system of claim 13, further comprising:
a programmable processor to execute software forming the logical multiplexer.

17. The system of claim 13, wherein the at least two fixed decommutator subsystems to receive identical data streams comprise:
a first fixed decommutator subsystem operable to segment a first data stream, to synchronize each segment to a first synchronization pattern of the first fixed decommutator, and to output first synchronized segments; and
and a second fixed decommutator subsystem operable to segment a second data stream, to synchronize each segment to a second synchronization pattern of the second fixed decommutator, and to output second synchronized segments, wherein the output from the logical multiplexer during one period comprised one first synchronized segment and one second synchronized segment.

18. A program product comprising program instructions, embodied on a storage medium, that are operable to cause a programmable processor to:
receive synchronized segments of the data stream from each of N fixed decommutator subsystems, wherein the synchronized segments sent from each of the N fixed decommutator subsystems are synchronized to a respective synchronization pattern;
periodically output (1/N)^{th} of the synchronized segments of the data stream received from each of the N fixed decommutator subsystems, wherein during each period, the N synchronized segments output from the logical multiplexer form a variable synchronized frame of the data stream.

19. The program-product of claim 18, further comprising instructions operable to cause the programmable processor to:
multiplex (1/N)^{th} of the synchronized segments received from each of the N fixed decommutator.

20. The program-product of claim 18, wherein the instructions operable to cause the programmable processor to multiplex (1/N)^{th} of the synchronized segments received from each of the N fixed decommutator subsystem further comprises instructions operable to cause the programmable processor to:
multiplex the first synchronized segment generated at time (nΔt+t₀) from the first copy of the data stream with the second synchronized segment generated at time (nΔt+½Δt+t₀) from the second copy of the data stream.
